(19) United States
(12) Patent Application Publication
(10) Pub. No.: US 2023/0191626 A1
(43) Pub. Date: Jun. 22, 2023

(54) A GRIPPER ASSEMBLY

(71) Applicant: OZ-SAN OTO YEDEK PARCA SAN. VE TIC. LTD STI., Yenimahalle, Ankara (TR)

(72) Inventor: Mahmut YESIL, Yenimahalle, Ankara (TR)

(21) Appl. No.: 17/996,115

(22) PCT Filed: Mar. 29, 2021
(86) PCT No.: PCT/TR2021/050278

§ 371 Date: Oct. 13, 2022

(30) Foreign Application Priority Data
Apr. 24, 2020 (TR) 2020/06451

(51) Int. Cl. B25J 15/00

(52) U.S. Cl. CPC B25J 15/0033

(57) ABSTRACT

Disclosed is a gripper assembly used in milling or CNC machines with one or more than one axes, adapted to grip the workpiece from two or more directions at the same time and with the same force.

### TECHNICAL FIELD

The present invention relates in particular to a gripper assembly, used in milling or CNC machines with one or more than one axes, and adapted to grip the workpiece from two or more directions at the same time and with the same force.

### PRIOR ART

The purpose of machine tools is to shape the raw material in a quality specified with tolerances. The shaping operation takes place by chip removal as a result of the relative movements of the tool and the workpiece. These movements specified by the program on CNC machines are converted into electronic signals by the control unit of the machine; and these signals activate the motor and the rolls and slides connected thereto by a mechanical transmission system (gear wheel, bolt mechanism, etc.). As a result of these movements, processing of the pieces is carried out.

Various fastening tools are used to process workpieces on CNC machines. The characteristic of these fastening tools has an effect on properties such as the machining properties, cutter performance, and workpiece surface quality, etc. Since CNC machines are high-powered and robust, and remove large amounts of chips, workpiece fastening tools require great care and occupational safety. They may be grouped as special fastening apparatuses or standard fastening apparatuses according to the shape and characteristic of the cutter used. While placing the workpieces, the principles of fastening the workpiece so that it can respond to the cutting forces, providing sufficient support under the piece, and fast and easy tightening or releasing are very important. One of the most widely used methods for fastening workpieces is fastening to the plate using vices. Before the workpiece is correctly placed in the vice, great attention should be given to properly fastening the workpiece in the vice square to the machining plate. Another method of fastening workpieces to the milling plate is the method of fastening with bolts and lugs. This method is generally used in cases where fastening with a vice is not possible, in the case of large workpieces, and in fastening workpieces formed with different surface shapes.

However, said fastening apparatuses can only hold the workpiece from two sides and therefore the workpiece cannot be fully gripped. If a force is applied to the workpiece from the other two sides of the workpiece that cannot be held, the workpiece can be freed from the vice, and in this case, the workpiece may detach from the vice before its machining is completed. In addition, because the workpiece is gripped only from two sides, the holding force is higher compared to gripping from all directions, and this situation creates the risk of crushing the workpiece in the vice.

### OBJECTS OF THE INVENTION

The object of the present invention is to realize a gripper assembly adapted to grip the workpiece from all sides.

Another object of the present invention is to realize a gripper assembly adapted to grip the workpiece by applying less pressure force than the pressure force generated when the workpiece is pressed from two sides.

Another object of the present invention is to realize a gripper assembly adapted such that gripping elements located on all four sides can move simultaneously.

Another object of the present invention is to realize a gripper assembly adapted such that the gripping elements located on all four sides can grip by applying the same force.

### BRIEF DESCRIPTION OF THE INVENTION

The gripper assembly realized in order to achieve the object of the present invention and defined in the first claim and the other claims dependent on this claim includes a plate, one or more drive elements, a synchronous guide and two or more grippers. The workpiece is processed by means of holding elements placed on each of said grippers and the process is completed in this way.

### DETAILED DESCRIPTION OF THE INVENTION

The gripper assembly realized to achieve the object of the present invention is shown in the attached figures, wherein;

FIG. 1. Perspective view of the gripper assembly together with the holding element in its open state.

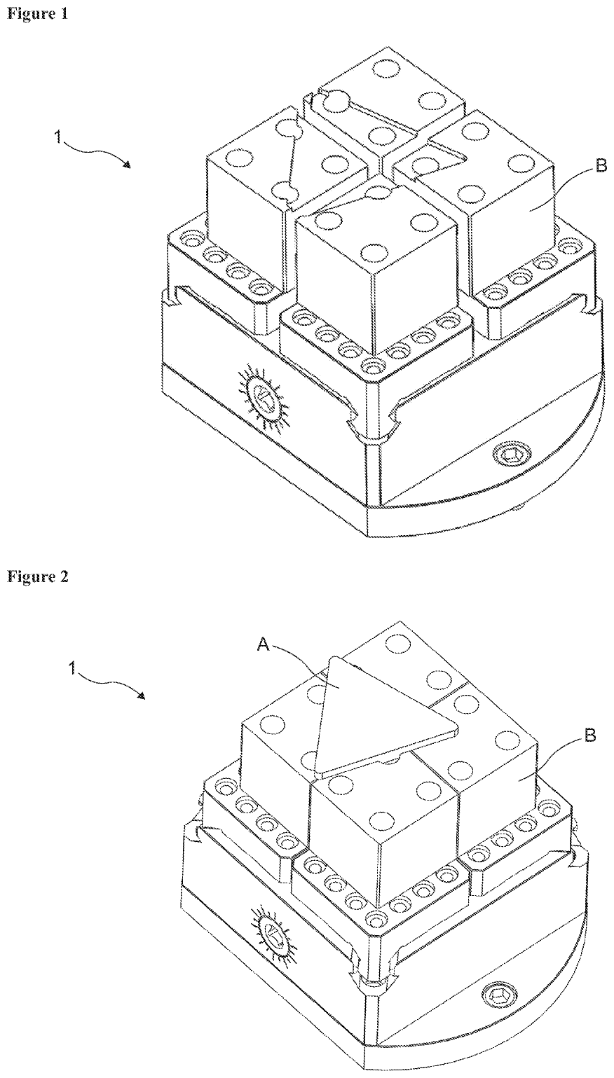

FIG. 2. Perspective view of the gripper assembly together with the workpiece and holding element in its closed state.

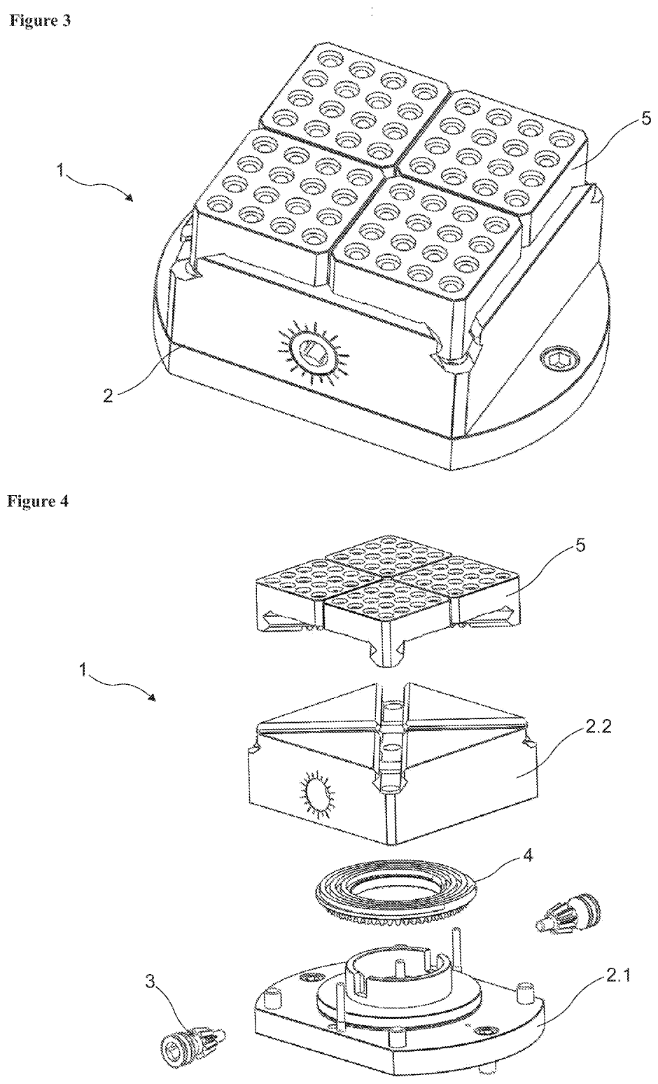

FIG. 3. Perspective view of the gripper assembly in its closed state.

FIG. 4. Exploded perspective view of the gripper assembly in its closed state.

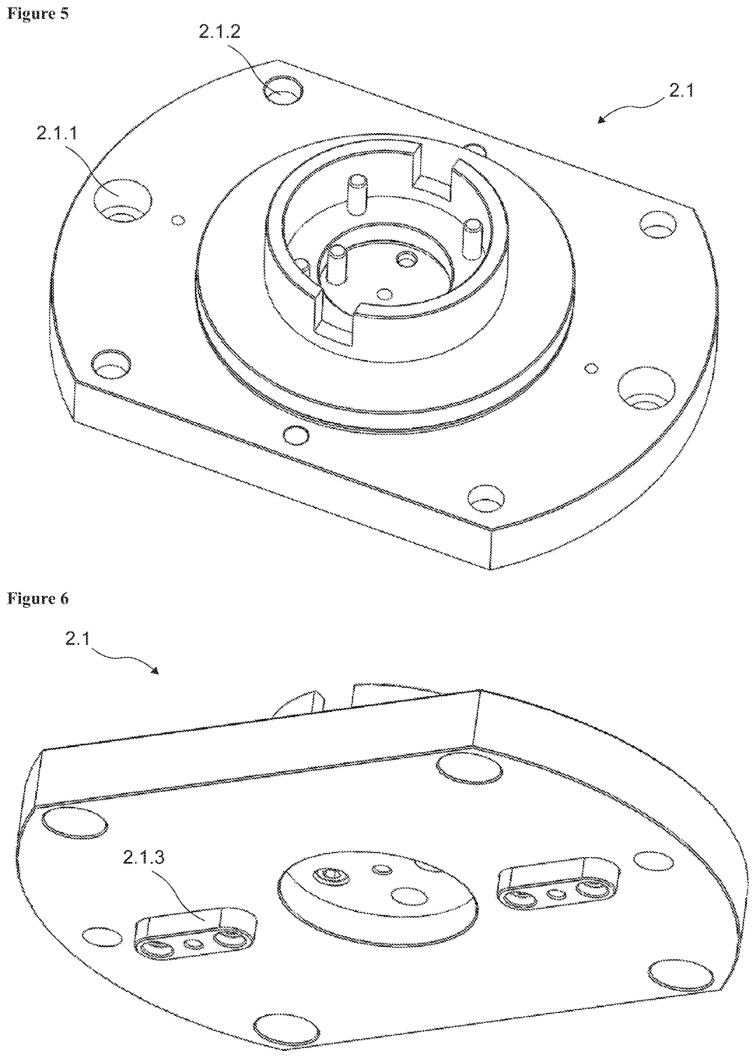

FIG. 5. Perspective view of the fastening plate.

FIG. 6. Another perspective view of the fastening plate.

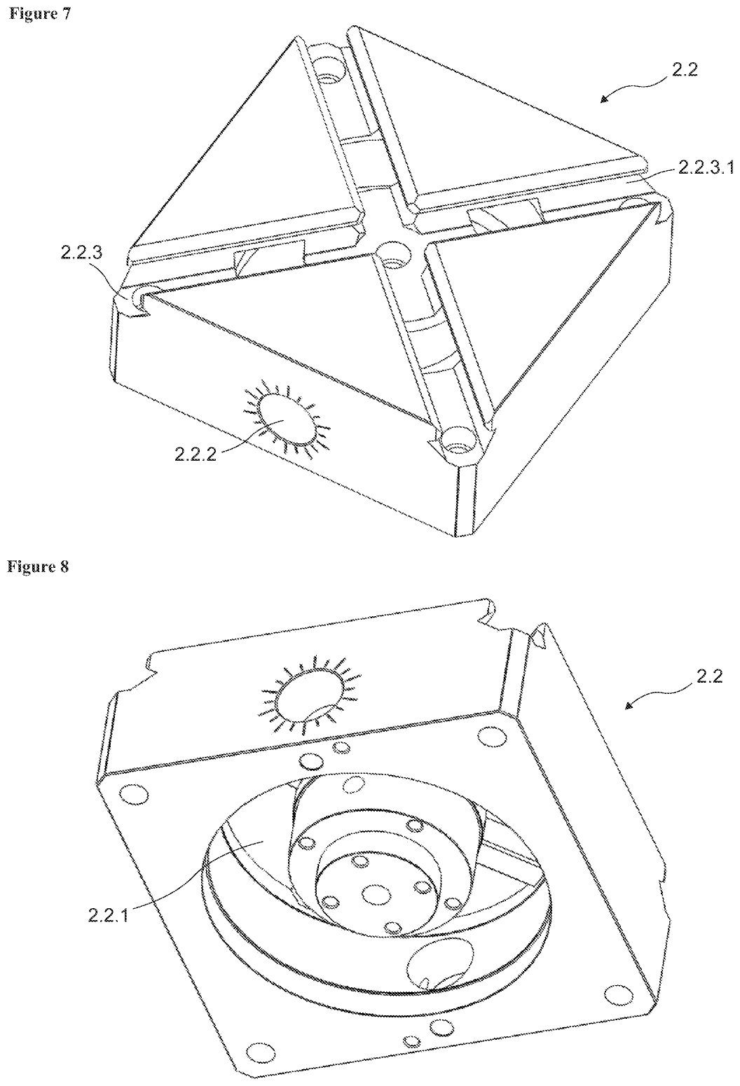

FIG. 7. Perspective view of the grip plate.

FIG. 8. Another perspective view of the grip plate.

FIG. 9. Perspective view of the fastening plate together with the synchronous guide and drive element.

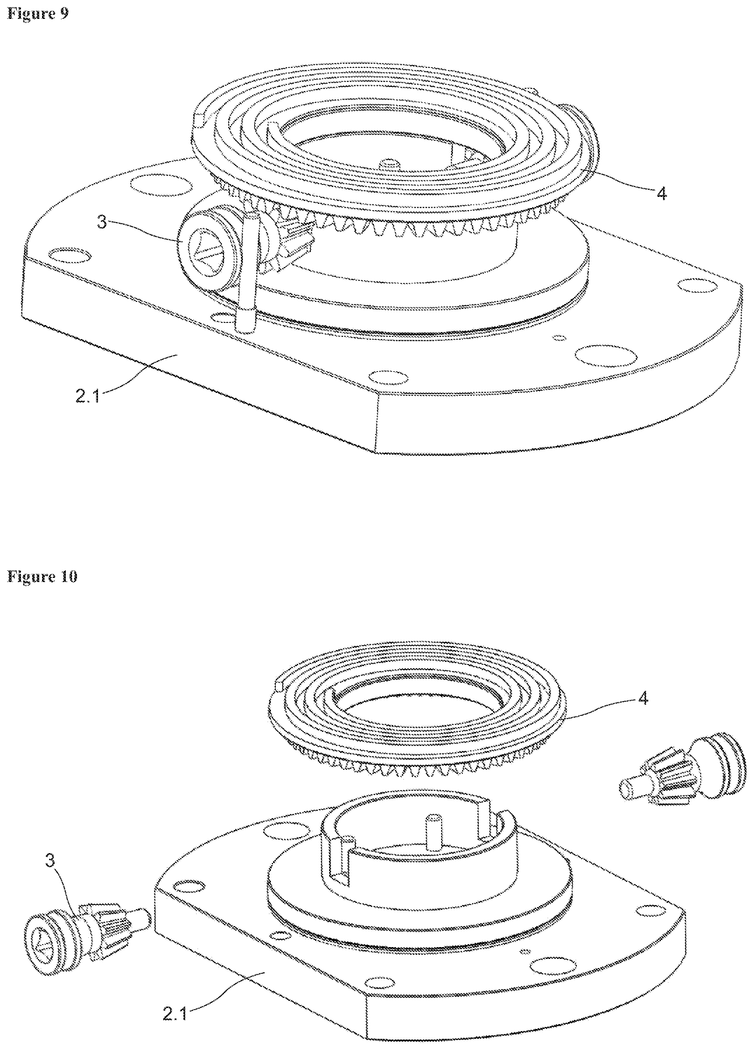

FIG. 10. Exploded perspective view of the fastening plate together with the synchronous guide and drive element.

FIG. 11. Perspective view of the synchronous guide.

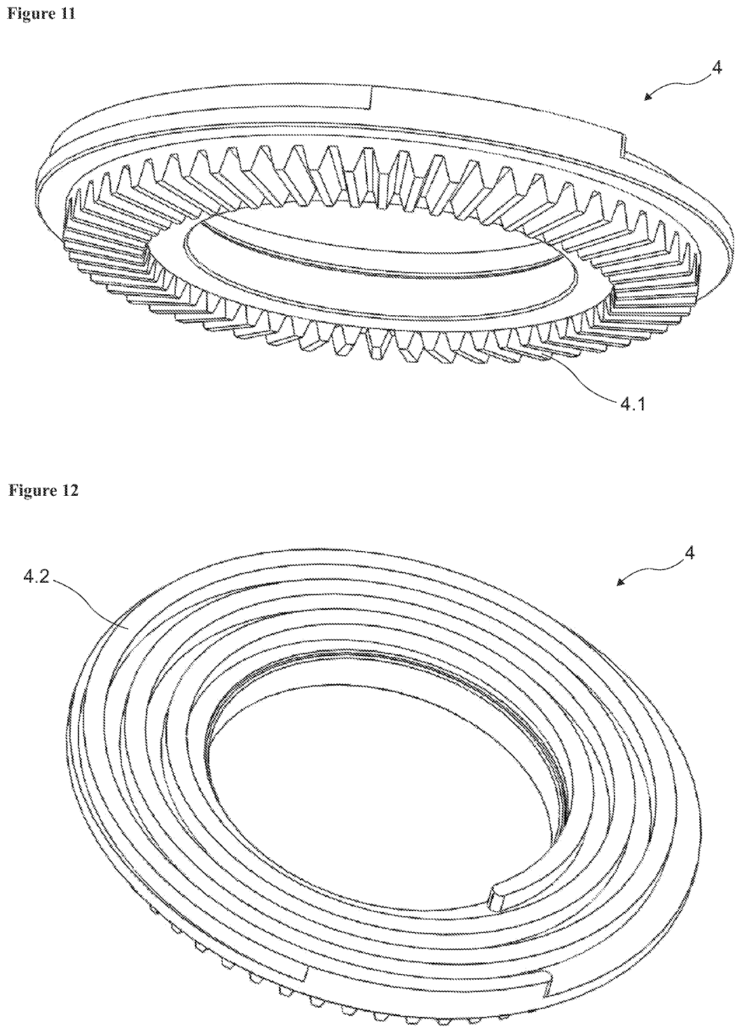

FIG. 12. Another perspective view of the synchronous guide.

FIG. 13. Sectional perspective view of the grip plate.

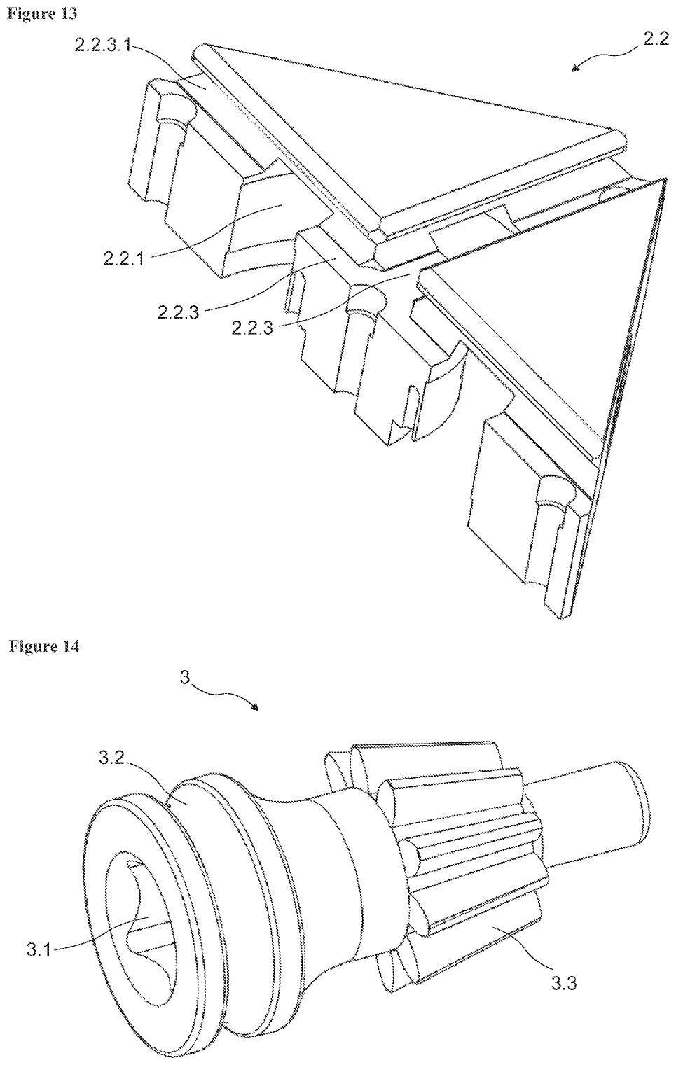

FIG. 14. Perspective view of the drive element.

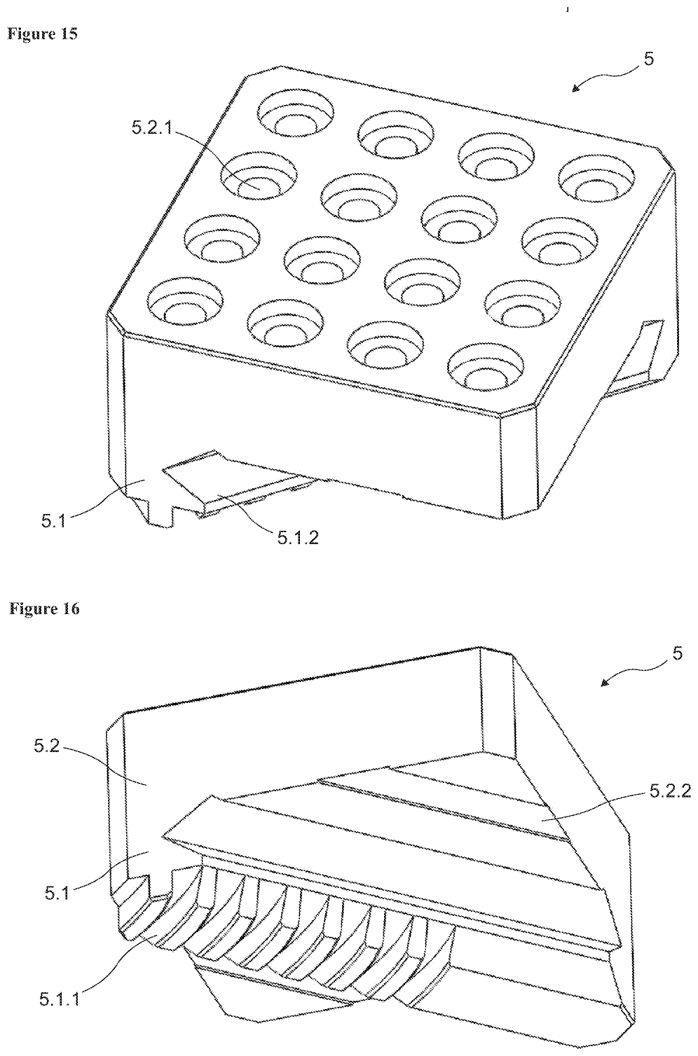

FIG. 15. Perspective view of the gripper.

FIG. 16. Another perspective view of the gripper.

The components given in the figures are enumerated individually, and the meanings of these numbers are given below.
1. Gripper assembly
2. Plate
2.1. Fastening plate
2.1.1. Fastening holes
2.1.2. Mounting holes
2.1.3. Fastening extension
2.2. Grip plate
2.2.1. Gap
2.2.2. Drive hole
2.2.3. Movement channel
2.2.3.1. Inclined channel
3. Drive element
3.1. Rotation gap
3.2. Seating recess
3.3. Drive tooth
4. Synchronous guide
4.1. Rotation tooth
4.2. Spiral channel
5. Gripper
5.1. Guide element
5.1.1. Movement tooth
5.1.2. Inclined protrusion
5.2. Holding body
5.2.1. Fastening gaps
5.2.2. Friction channel
A. Workpiece
B. Holding element

The gripper assembly (1), particularly used in milling or CNC machines with one or more axes, adapted to grip the workpiece from two or more directions at the same time and with the same force, essentially comprises:
at least one plate (2) for fastening to milling or CNC machines,
at least one drive element (3), adapted to rotate around its own axis by means of a rotation apparatus, and driven for gripping the workpiece (A) in case fastening of the workpiece (A) is preferred for processing thereof,
at least one synchronous guide (4) adapted to operate synchronously with the drive element (3), and can rotate around the central axis by being driven by the drive element (3), when the drive element rotates around its own axis as a result of being driven,
at least two grippers (5), which are formed for gripping the workpiece (A),
   which are adapted to be driven when the synchronous guide (4) is rotated about its central axis,
   which enable the workpiece (A) to be gripped by approaching towards the central axis of the synchronous guide (4) when the synchronous guide (4) is rotated around its central axis in one direction,
   which allow the workpiece (A) to be released by moving away from the central axis of the synchronous guide (4) when the synchronous guide (4) is rotated around its central axis in another direction.

There is at least one plate (2) in the gripper assembly (1) in an embodiment of the present invention. Said plate (2) is the main component of the gripper assembly (1) and ensures that all other elements are kept together. The plate (2) provided in the gripper assembly (1) enables fastening of the gripper assembly (1) to the CNC or milling machine. The plate (2) provided this embodiment of the invention consists of two separate parts, the fastening plate (2.1) and the grip plate (2.2). The fastening plate (2.1) forms the lowest part of the gripper assembly (1) and there are more than one fastening holes (2.1.1) on the plate. By inserting a fastener element through these fastening holes (2.1.1), the fastening plate (2.1) and the CNC or milling machine are mounted to each other and a fixed connection is provided. In the fastening plate (2.1) of this embodiment of the invention, there are also mounting holes (2.1.2). The mounting holes (2.1.2) are formed to accommodate the necessary fastener elements required to mount and fix the grip plate (2.2) located on the plate (2) to the fastening plate (2.1). The fastening plate (2.1) and the grip plate (2.2) are fixed to each other using the fastener elements inserted through these mounting holes (2.1.2), thus forming the plate (2). In the fastening plate (2.1) of this embodiment of the invention, there are also more than one fastening extensions (2.1.3). The said fastening extension (2.1.3) is located on the side of the fastening plate (2.1) that is fastened to the CNC or milling machine, and they are formed in the fastening plate (2.1) to help the attachment of the fastener elements inserted through the fastening holes (2.1.1).

In this embodiment of the invention, the grip plate (2.2), which is another component of the plate (2), is positioned on the upper part of the fastening plate (2.1) to complement the fastening plate (2.1) and form the plate (2). The grip plate (2.2) is the component in which the drive element (3), the synchronous guide (4), and the grippers (5) used to grip the workpiece (A) are held together and are allowed to move. A gap (2.2.1) is provided in the centre of the grip plate (2.2) provided in this embodiment of the invention. The said gap (2.2.1) is formed starting from the lowest part of the grip plate (2.2) to a place close to the top part. The synchronous guide (4) can be placed in this gap (2.2.1) such that it can rotate around its own central axis. In this embodiment of the present invention, at least one drive hole (2.2.2) other than the gap (2.2.1) is provided in the grip plate (2.2). The said drive hole (2.2.2) is formed in the grip plate (2.2) so that the drive element (3) can be mounted on the grip plate (2.2). In this embodiment of the invention, two opposing drive holes (2.2.2) are formed, and if it is preferred in different embodiments of the invention, three or four drive holes (2.2.2) can be formed. The main purpose of forming the opposing drive holes (2.2.2) is to be able to ensure driving from both opposite sides with an angle of 180°. In this embodiment of the present invention, at least two movement channels (2.2.3) are formed to move the gripper (5) on the opposite part of the grip plate (2.2) which is not mounted to the fastening plate (2.1). The grippers (5) can move inside said movement channels (2.2.3). In this embodiment of the invention, the direction of the movement channel (2.2.3) intersects with the central axis of the synchronous guide (4). Thus, when driving the synchronous guide (4), it is ensured that the grippers (5) can move in the direction of the synchronous guide (4) central axis. At least two movement channels (2.2.3) are formed, or three, four or more than four channels can be formed in different embodiments of the invention. The movement channel (2.2.3) in this embodiment of the invention also has an inclined channel (2.2.3.1), and said inclined channel (2.2.3.1) is formed on the sides of the movement channel (2.2.3) so that the gripper (5) fits into the movement channel (2.2.3) and does not come out. The inclined channel (2.2.3.1) in this embodiment of the invention is formed with an angle of 45°.

In the gripper assembly (1) provided in this embodiment of the present invention, at least one drive element (3) is formed to provide the first drive so that the workpiece (A) can be gripped. Said drive element (3) is such that it can be rotated around its own central axis and has a rotation gap (3.1) on one side. A rotation element is inserted through said rotation gap (3.1) and in this way, the drive element (3) can be rotated around its own axis. In this embodiment of the present invention, a seating recess (3.2) is provided in a region of the drive element (3) close to the rotation gap (3.1). This seating recess (3.2) is formed in the drive element (3) in order to prevent the drive element (3) from coming out of the drive hole (2.2.2) after the drive element (3) is mounted to the drive hole (2.2.2). A blocking extension is placed in the rotation gap (3.1) and thus the drive element (3) is prevented from leaving the place where it is located. Also a drive tooth (3.3) is provided in the drive element (3) of this embodiment of the present invention. Said drive tooth (3.3) is located on the side where the rotation gap (3.1) is not present, and it is the component that transmits this drive when the drive element (3) is driven. In other words, the torque generated by a rotation apparatus in the drive element (3) is transmitted to the synchronous guide (4) via this drive tooth (3.3).

Also a synchronous guide (4) is provided in the gripper assembly (1) of this embodiment of the present invention. Said synchronous guide (4) is adapted to rotate around its central axis with the moment force it receives from the drive element (3). In this embodiment of the invention, a rotation tooth (4.1) is provided on the side of the synchronous guide (4) that interacts with the drive tooth (3.3). Said rotation tooth (4.1) is adapted to be placed with an angle of 360° around the synchronous guide (4). Said rotation tooth (4.1) is in interaction with the drive tooth (3.3) and the rotation force transmitted through the drive tooth (3.3) is transmitted to the synchronous guide (4) via this rotation tooth (4.1). In other words, when the drive element (3) rotates around its own axis, the synchronous guide (4) also rotates around its own axis, similarly. In this embodiment of the invention, a spiral channel (4.2) is provided on the other side of the synchronous guide (4) which does not have a turning tooth (4.1). Said spiral channel (4.2), on the other hand, can move the gripper (5) towards the central axis when it is rotated in one direction around its central axis thanks to its helical structure, and when it is rotated in the other direction, it can move the gripper (5) towards the opposite direction of the specified direction. Since the spiral channel (4.2) provided in the synchronous guide (4) of this embodiment of the present invention is placed with an angle of 360°, it can move more than one gripper (5) at the same time and in the same direction. At least two grippers (5) are mounted to the synchronous guide (4) in this embodiment of the present invention. If preferred, in different applications of the invention, three, four or more than four grippers (5) can be made to interact with the synchronous guide (4), and all of them can be moved at the same time.

In this embodiment of the present invention, also a gripper (5) is provided in the gripper assembly (1). Said gripper (5) helps to grip the workpiece (A) as a result of the movement of the synchronous guide (4) in the direction of its central axis, and as a result of the movement of the synchronous guide (4) in the opposite direction to its central axis, it helps the release of the workpiece (A). In this embodiment of the present invention, there is a guide element (5.1) in the part of the gripper (5) that interacts with the spiral channel (4.2). Said guide element (5.1) is seated in the movement channel (2.2.3) located on the grip plate (2.2), and adapted to move the gripper (5) within the said movement channel (2.2.3). In this embodiment of the invention, a movement tooth (5.1.1) is provided in the guide element (5.1), and this movement tooth (5.1.1) is adapted to interact with the spiral channel (4.2) in the synchronous guide (4). The movement tooth (5.1.1) is a structure consisting of more than one extension and gaps, and said gaps fit into the spiral channel (4.2) located in the synchronous guide (4), and when the spiral channel (4.2) is rotated around the central axis, the gripper (5) is driven by means of the movement tooth (5.1.1) and is subjected to movement. In this embodiment of the invention, there is an inclined protrusion (5.1.2) provided in the guide element (5.1). Said inclined protrusion (5.1.2) fits into the inclined channel (2.2.3.1) and prevents the guide element (5.1) from moving out upward through the movement channel (2.2.3). The inclined protrusion (5.1.2) in this embodiment of the invention is formed with an angle of 45°. Thus, the gripper (5) does not come out of the movement channel (2.2.3). In the gripper (5) in this embodiment of the present invention, apart from the guide element (5.1), also a holding body (5.2) is provided. The holding body (5.2) is the part adapted to hold any work piece (A). Fastening gaps (5.2.1) are provided in said holding body (5.2). With the fastener elements mounted in these fastening gaps (5.2.1), the holding element (B) is placed on the holding body (5.2) and in this way, workpieces (A) in any geometric form can be processed by means of different holding elements (B). In this embodiment of the present invention, also a friction channel (5.2.2) is provided in the retainer body (5.2). Said friction channel (5.2.2) is formed on the other side where there are no fastening gaps (5.2.1) in the holding body (5.2), in other words, on the side of the holding body (5.2) that is in a friction relationship with the grip plate (2.2). The friction between the holding body (5.2) and the grip plate (2.2) is reduced by means of said friction channel (5.2.2), and also the friction between the holding body (5.2) and the grip plate (2.2) is minimized by means of the lubricants directed into this friction channel (5.2.2).

The operation of the gripper assembly (1) in this embodiment of the invention is carried out as follows. While the plate (2) in the gripper assembly (1) is fully assembled, the fastening plate (2.1) is found at the bottom and the grip plate (2.2) is found at the top. The gripper assembly (1) is mounted to the milling or CNC machine by means of this fastening plate (2.1). The grip plate (2.2) is the plate where the drive element (3) and the synchronous guide (4) required for the movement of the gripper (5) are maintained. In the gripper assembly (1) in this embodiment of the present invention, two drive elements (3) are placed opposite to each other (180° to each other). Both of these drive elements (3) interact with the synchronous guide (4) and are positioned so as to be able to drive the synchronous guide (4). In this embodiment of the invention, the synchronous guide (4) is adapted to be readily driven as positioned in the gap (2.2.1) provided on the grip plate (2.2). In this embodiment of the present invention, four grippers (5) are used, and all of these grippers (5) are in interaction with the synchronous guide (4). On the gripper (5), a holding element (B) that can be formed in any geometric form according to the geometric form of the workpiece (A) is provided. By means of this holding element (B), the workpiece (A) in all forms can be held and processing can be carried out in this way. In the gripper assembly (1) in this embodiment of the present invention, the first drive is carried out by placing a rotation apparatus in the rotation gap (3.1) located in the drive element (3) and rotating said rotation apparatus in one direction. In this case, the drive element (3) is also subjected to rotation around its own axis and in this way, the drive is transferred to the rotation teeth (4.1) in the synchronous guide (4) via the drive tooth (3.3). Said rotation tooth (4.1) enables the synchronous guide (4) to rotate around its central axis. When the synchronous guide (4) rotates around its central axis, naturally the spiral channels (4.2) located in the synchronous guide (4) also move and interact with the movement tooth (5.1.1) in the gripper (5). In this case, since it is driven by the movement tooth (5.1.1), the gripper (5) moves towards the central axis of the synchronous guide (4). In this embodiment of the present invention, there are four grippers (5) and when the synchronous guide (4) rotates around its central axis, these four grippers (5) move at the same time and at the same speed towards the central axis of the synchronous guide (4). Said movement continues until the holding element (B) on the gripper (5) fully grips the workpiece (A), and this movement ends when the workpiece (A) is fully gripped. In this case, the workpiece (A) is gripped from all four sides with the same force. After the completion of the processing of the workpiece (A), if it is preferred to separate the workpiece (A) from the gripper assembly (1), the rotation apparatus is placed again in the rotation gap (3.1) and in this case, the rotation apparatus is rotated in the opposite direction to the direction it was first rotated. In this case, similarly, the drive element (3) drives the synchronous guide (4), and the synchronous guide (4) drives the grippers (5) in the opposite direction, enabling the grippers (5) to move in the opposite direction from the synchronous guide (4) central axis. In this case, the workpiece (A) is separated and released from the holding elements (B).

1. (canceled)

2. (canceled)

3. (canceled)

4. (canceled)

5. (canceled)

6. (canceled)

7. (canceled)

8.(canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. A gripper assembly, particularly used in milling or CNC machines with one or more than one axes, adapted to grip a workpiece from two or more directions at the same time and with the same force, the gripper assembly comprising:
at least one plate for fastening to milling or CNC machines;
at least one drive element, adapted to rotate around its own axis by means of a rotation apparatus, and driven for gripping the workpiece in case fastening of the workpiece is preferred for processing thereof;
at least one synchronous guide adapted to operate synchronously with the drive element, and can rotate around the central axis by being driven by the drive element, when the drive element rotates around its own axis as a result of being driven;
at least two grippers, which are formed for gripping the workpiece;
wherein the at least two grippers are adapted to be driven when the synchronous guide is rotated about its central axis;
wherein the at least two grippers enable the workpiece to be gripped by approaching towards the central axis of the synchronous guide when the synchronous guide is rotated around its central axis in one direction;
wherein the at least two grippers allow the workpiece to be released by moving away from the central axis of the synchronous guide when the synchronous guide is rotated around its central axis in another direction.

39. The gripper assembly according to claim 38, wherein the plate enables fastening the workpiece to the CNC or milling machine, and consists of two separate parts, the fastening plate and the grip plate.

40. The gripper assembly according to claim 39, wherein the fastening plate has more than one fastening hole that enables mounting to the CNC or milling machine by inserting a fastener element, mounting holes formed for placing the fastener elements required to mount and fix the grip plate located on the plate to the fastening plate and a fastening extension which is located on the side of the fastening plate that is fastened to the CNC or milling machine, and which is formed in the fastening plate to help the attachment of the fastener elements inserted through the fastening holes.

41. The gripper assembly according to claim 39, wherein the grip plate is positioned on the upper part of the fastening plate to complement the fastening plate and form the plate.

42. The gripper assembly according to claim 39, wherein the grip plate, which is the component on which the drive element, the synchronous guide, and the grippers used to grip the workpiece are held together and allowed to move, and on which a gap is formed in the centre, starting from the lowest part of the grip plate to a place close to the top part and where the synchronous guide is placed to be rotated around its central axis.

43. The gripper assembly according to claim 39, wherein the grip plate has a drive hole formed in the grip plate so that the drive element can be mounted on the grip plate and two opposite drive holes formed to drive from both opposing sides in the grip plate with an angle of 180°.

44. The gripper assembly according to claim 39, wherein the grip plate has at least two movement channels formed for the gripper to move on the opposite part of the grip plate that is not mounted to the fastening plate and having the movement channel, the direction of which intersects with the central axis of the synchronous guide to enable the grippers to move in the direction of the central axis of the synchronous guide when the synchronous guide is driven and having the inclined channel provided in the movement channel and formed on the sides of the movement channel so that the gripper fits into the movement channel and does not come out.

45. The gripper assembly according to claim 44, wherein the drive element can be rotated around its own central axis and has a rotation gap on one side through which a rotation element can be inserted and which having a rotation gap, a seating recess and a drive tooth formed to provide the first drive so that the workpiece can be gripped, and is provided in a region of the drive element close to the rotation gap, and which is formed in the drive element to prevent the drive element from coming out of the drive hole after the drive element is mounted to the drive hole.

46. The gripper assembly according to claim 45, wherein the drive tooth is located on the side where there is no rotation gap and transmits the drive to the synchronous guide when the drive element is driven.

47. The gripper assembly according to claim 38, wherein the synchronous guide has a rotation tooth which adapted to be placed with an angle of 360° around the synchronous guide on the side that interacts with the drive tooth and interacts with the drive tooth and enables the rotation force transmitted through the drive tooth to be transferred to the synchronous guide, and a spiral channel, and adapted to rotate around the central axis with the moment force it receives from the drive element.

48. The gripper assembly according to claim 47, wherein the spiral channel is located on the other side of the synchronous guide that does not have any rotation tooth, and can move the gripper towards the central axis of the synchronous guide when it is rotated in one direction around the central axis thanks to its helical structure, and which can move the gripper towards the opposite direction to the specified direction when it is rotated in the other direction and which is formed with an angle of 360° and adapted to move more than one gripper at the same time and in the same direction.

49. The gripper assembly according to claim 38, wherein the gripper has a holding body adapted to hold the workpiece in any geometric form and that helps to grip the workpiece as a result of the movement of the guide in the direction of the central axis, and helps to release the workpiece as a result of the movement of the synchronous guide in the opposite direction to the central axis direction and which adapted to move towards the synchronous guide central axis at the same time and at the same speed when the synchronous guide rotates around its central axis.

50. The gripper assembly according to claim 49, wherein the gripper has a guide element on the part that interacts with the spiral channel and which is seated in the movement channel located in the grip plate, and is adapted to enable the movement of the gripper within said movement channel.

51. The gripper assembly according to claim 50, wherein the guide element has a movement tooth adapted to interact with the spiral channel in the synchronous guide.

52. The gripper assembly according to claim 50, wherein the guide element has a movement tooth, which is a structure consisting of more than one extensions and gaps, these gaps fitting into the spiral channel located in the synchronous guide, and when the spiral channel is rotated around the central axis, the movement tooth driving the gripper and subjecting it to movement and which having the inclined protrusion that is seated inside the inclined channel and prevents the guide element from coming out of the movement channel in the upward direction.

53. The gripper assembly according to claim 49, wherein the gripper has a holding body, on which the holding element is placed with the fastener elements mounted in the fastening gaps and in this way, adapted for processing workpieces in any geometric form by means of different holding elements, and which comprising the friction channel, which is formed on the other side where there are no fastening gaps in the holding body, in other words, on the side of the holding body that is in a frictional relationship with the grip plate.

54. The gripper assembly according to claim 49, wherein the gripper has a holding body comprising the friction channel, which is adapted to reduce the friction between the holding body and the grip plate by means of the lubricants directed therein.

55. The gripper assembly according to claim 38, comprising two drive elements, which are placed to be opposite to each other at a distance of 180°, and positioned to interact with the synchronous guide and to drive the synchronous guide.

56. The gripper assembly according to claim 44, wherein the inclined channel is formed with an angle of 45°.

57. The gripper assembly according to claim 50, wherein the guide element has an inclined protrusion formed with an angle of 45°.
